(19) United States
(12) Patent Application Publication
(10) Pub. No.: US 2015/0337861 A1
(43) Pub. Date: Nov. 26, 2015

(54) APPARATUS TO SUPPORT COMPONENTS OF A FLUID HANDLING SYSTEM AND IMPLEMENTATION THEREOF

(71) Applicant: Howden Roots LLC, Wilmington, DE (US)

(72) Inventors: David Charles Hokey, Brookville, OH (US); Micah Noel Maliskas, Oxford, IN (US)

(21) Appl. No.: 14/505,533

(22) Filed: Oct. 3, 2014

Related U.S. Application Data
(60) Provisional application No. 62/002,284, filed on May 23, 2014.

(51) Int. Cl. F04D 29/66; F16M 13/00

(52) U.S. Cl. CPC F04D 29/663; F16M 13/005

(57) ABSTRACT

A support structure with a mounting area to receive a fluid moving unit (e.g., a compressor, a blower, etc.) of a fluid-handling system. The support structure is configured to support the fluid moving unit in position at a plant or facility. In one embodiment, the support structure includes an enclosure with an interior cavity having an inlet and an outlet, which couples with the fluid-moving unit. Inside of the interior cavity, the enclosure can comprise a noise reduction structure to dissipate energy in a flow of working fluid that flows between the inlet and the outlet in response to operation of the fluid-moving unit. The noise reduction structure can include a pair of tubular members that extend along a longitudinal axis within the mounting area. Each of the tubular structures have a hollow interior and openings that expose the hollow interior to the interior cavity.

### CROSS-REFERENCE TO RELATED APPLICATIONS

This application claims priority to U.S. Provisional Application Ser. No. 62/002,284, filed on May 23, 2014, and entitled “SUPPORT STRUCTURE,” the content of which is incorporated by reference herein in its entirety.

### BACKGROUND

The subject matter disclosed herein relates to noise attenuation in material-moving machinery, with particular discussion about a support structure that can suppress noise and pulses in fluid-handling systems that incorporate blowers and compressors.

Industrial machinery like blowers and compressors employ impellers of varying styles to move large volumes of material (e.g., gas, liquids, powders, etc.). Rotary styles, for example, can use one or more large lobed-impellers. By design, the lobed-impellers mesh with one another to transfer material from an inlet to an outlet. This feature can generate significant pressure and flow pulses during operation. These flow pulses can resonate downstream and, in turn, induce vibrations of a magnitude that is often significant enough to damage equipment found downstream of the machinery and/or to generate noise at levels that are unsatisfactory even for industrial settings.

Remediation of the problems with flow pulses typically seeks to dissipate energy at the inlet and/or the outlet of the machinery. The solutions often employ noise reduction devices (e.g., silencers) to attenuate sound waves and like perturbations in the working fluid. These devices utilize elements (e.g., baffles) in different arrangements to modify the direction (and other aspects) of the flow of working fluid and, thus, effectively reduce noise and vibrations. Unfortunately, in most conventional implementations, the silencers mount to the exterior of the machinery. This configuration elongates the overall footprint of the machinery, sometimes by as much as 400% or more.

### BRIEF DESCRIPTION OF THE INVENTION

This disclosure describes embodiments that package the structure necessary to dampen noise and flow pulses at the inlet and/or outlet of the machinery with the structure that supports the machinery at the point of installation. The resulting package does not add to the footprint of the machinery. Moreover, the package operates as a platform that an end user (e.g., a plant operator) can manipulate without the need to remove and/or extract one or more operative components of the machinery from the support structure.

### BRIEF DESCRIPTION OF THE DRAWINGS

Reference is now made briefly to the accompanying drawings, in which:

FIG. 1 depicts a schematic diagram of perspective view of an exemplary embodiment of a support structure that is configured for noise reduction;

FIG. 2 depicts a perspective view of an exemplary embodiment of a support structure that is configured for noise reduction;

FIG. 3 depicts an elevation view of a first side of the support structure of FIG. 2;

FIG. 4 depicts an elevation view of a second side of the support structure of FIG. 2;

FIG. 5 depicts an elevation view of the front end of the support structure of FIG. 2;

FIG. 6 depicts an elevation view of the back end of the support structure of FIG. 2;

FIG. 7 depicts a perspective view of an exemplary embodiment of a support structure that is configured for noise reduction;

FIG. 8 depicts a perspective view of the support structure of FIG. 7 with parts removed to show an example of a noise reduction structure disposed in the interior;

FIG. 9 depicts an elevation, cross-section view of the support structure of FIG. 8 to illustrate a first side of the interior; and

FIG. 10 depicts an elevation, cross-section view of the support structure of FIG. 8 to illustrate a second side of the interior.

Where applicable like reference characters designate identical or corresponding components and units throughout the several views, which are not to scale unless otherwise indicated. Moreover, the embodiments disclosed herein may include elements that appear in one or more of the several views or in combinations of the several views.

### DETAILED DESCRIPTION

The discussion below describes embodiments of a support structure that can dampen noise and pulses associated with installation of blower and compressors. These installations typically utilize silencers for this purpose. However, conventional silencers, while necessary, increase the dimensions of the installation. As noted above, a footprint for a blower with convention silencers is often 400% larger than necessary to install just the blower (or compressor) and related operative devices. To this end, efforts were made to develop a solution that addresses noise and pulse problems in a much smaller, compact package.

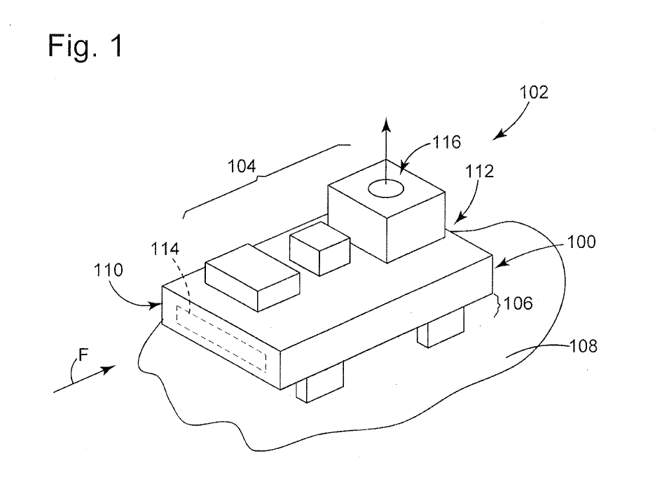

FIG. 1 depicts a schematic diagram of a perspective view of an exemplary embodiment of a support structure 100 that embodies this solution. This embodiment is part of fluid-handling system 102 that features a fluid moving unit 104 that mounts to the support structure 100. Examples of the fluid moving unit 104 include blowers and compressors, although the aspects of this disclosure can apply to use with other types of equipment. The support structure 100 rests on an isolator assembly 106 that elevates the support structure 100 off of the ground (and/or floor, mounting area, etc.), denoted generally by the numeral 108. The support structure 100 has a first end 100 and a second end 112. The first end 110 is configured with one or more openings (e.g., a first opening 114) that allow access to the interior of the support structure 100. As also shown in FIG. 1, the fluid moving unit 104 can include a first component 116 with an outlet (also, “discharge”). The outlet can couple with pipes and/or conduits found in many industrial applications (e.g., oil refineries, chemical and petrochemical plants, natural gas processing plants, etc.). Examples of the first component 116 are configured to move fluids (e.g., gasses and liquids) at varying flow properties (e.g., pressure, flow rate, etc.).

During operation, the first component 116 draws a working fluid F (e.g., air) into the support structure 100 through the first opening 114 at the first end 110. The working fluid F traverses the interior of the support structure 100, flowing from the support structure 100 into the fluid moving unit 104. In one implementation, the first component 116 discharges the working fluid F with properties (e.g., pressure, flow rate, etc.) that satisfy certain requirements for the corresponding application that employs the fluid-handling system 102.

The support structure 100 can reduce noise and vibration that results from propagation of waves and/or pulses that can occur during operation of the fluid moving unit 104. The embodiments herein offer a unique packaging solution that incorporates a noise reduction structure into the support structure 100. This noise reduction structure is configured to dissipate flow of the working fluid F, notably, to change the direction flow of the working fluid that transits the support structure 100 from one end to the other end. As an added benefit, the support structure 100 is constructed to fit both the noise reduction structure and the fluid moving unit 104, generally, within an installation envelope that requires less space to install in the facility. This construction is also configured with mechanical properties (e.g., strength) and utility to carry the weight of the fluid moving unit 104. This feature allows a plant operator to easily move, remove, replace, and reconfigure the fluid moving machinery 102 in the facility, without the need to disassemble the various components of the fluid moving unit 104 from the support structure 100.

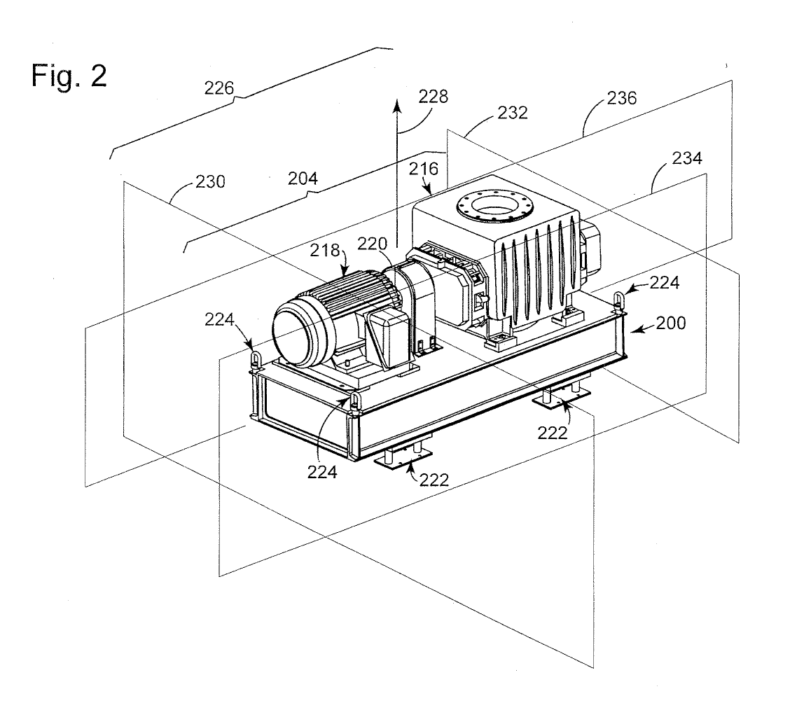

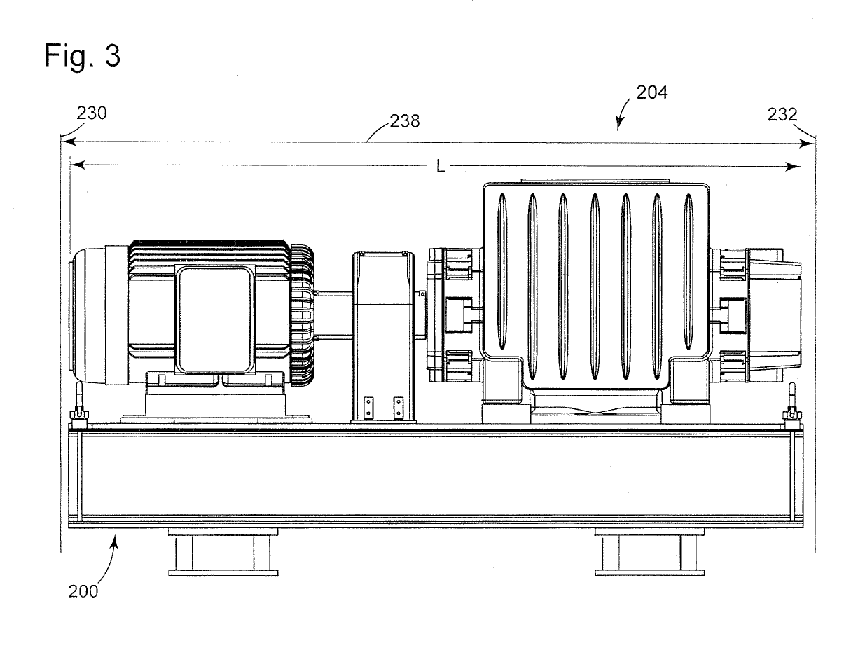

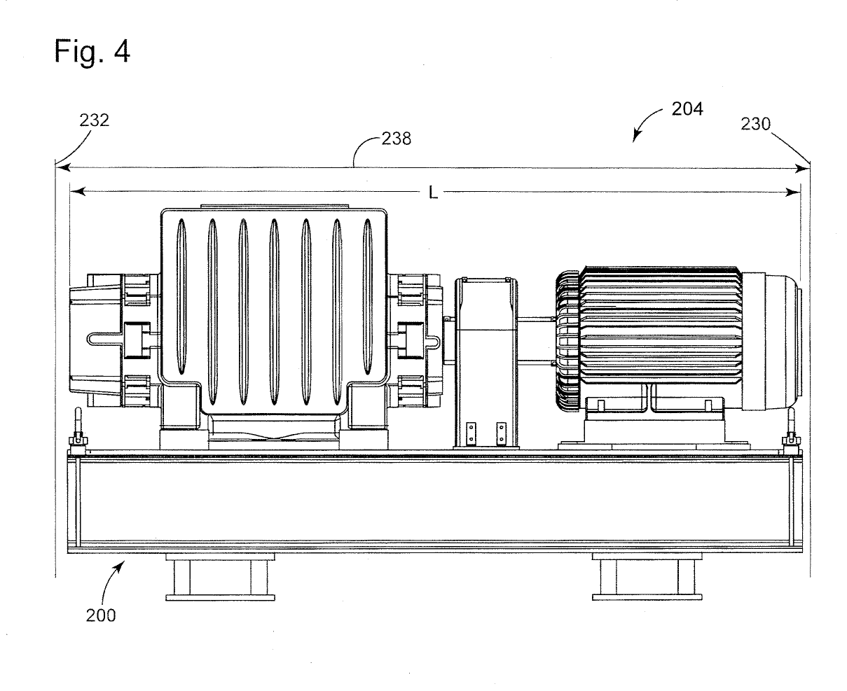

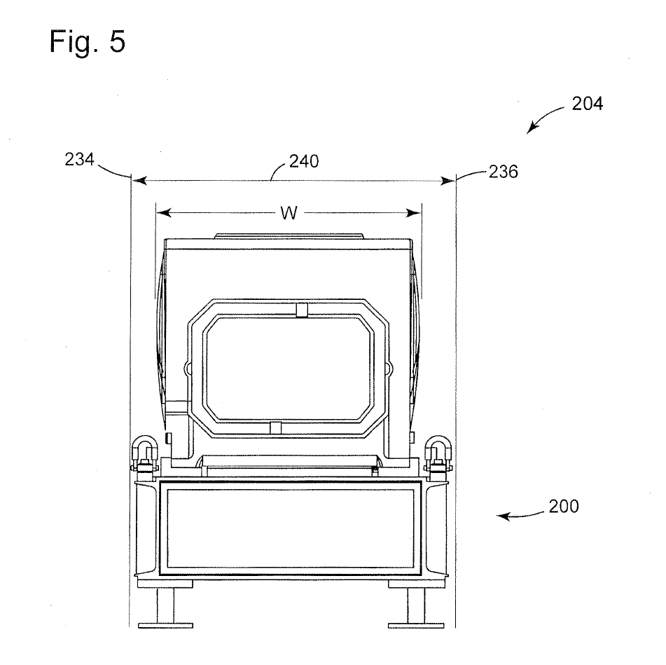

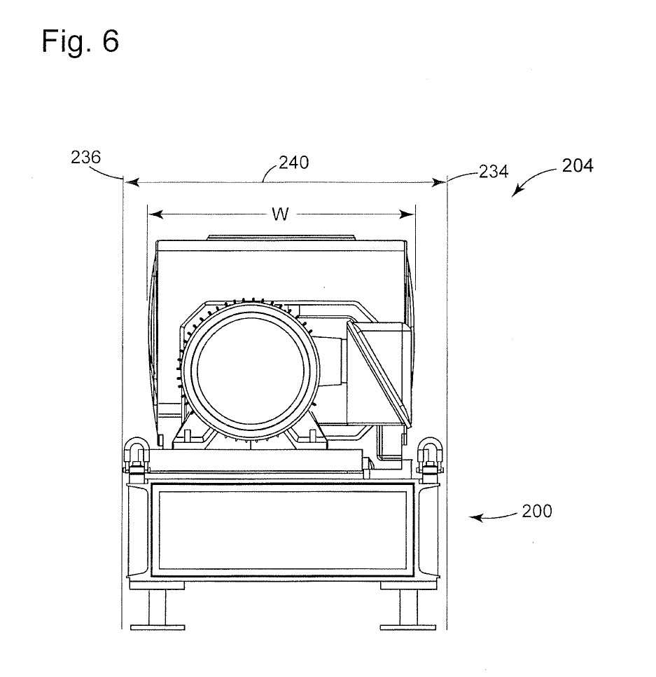

FIGS. 2, 3, 4, 5, and 6 depict various views of an exemplary embodiment of a support structure 200 to illustrate an example of this installation envelope. FIG. 2 shows a perspective view of the support structure 200. FIGS. 3 and 4 show side, elevation views of the support structure 200. FIGS. 5 and 6 illustrate elevations views of a second end (FIG. 5) and a first end (FIG. 6) of the support structure 200. In conventional applications, operation of the fluid moving unit 204 draws working fluid into the first end of the support structure 200. The working fluid traverses the support structure 200, exiting (or discharging) from a component of the fluid moving unit 204 as noted more below.

The fluid moving unit 204 can include components often associated with compressor, blower, and related technologies. In FIG. 2, the first component 216 (also, “blower component 216”) couples with a motor component 218 via a coupling component 220. Examples of the first component 216 include the blower and/or compressor disclosed herein. The isolation assembly 206 can include one or more stanchions 222 that provide an interface between the support structure 200 and the ground (e.g., ground 108 of FIG. 1). In one example, the support structure 200 has one or more lifting members 224 that are configured to direct a load to the components of the support structure 200 (and/or the enclosure of the support structure 200, as noted below). In one example, the lifting members 224 embody hooks and/or rings. The support structure 200 fits within an installation envelope 226 with boundaries that may define the outer, dimensional extent of the fluid moving unit 204. The boundaries can embody a plurality of planes. In one example, these planes include two sets of parallel planes that extend along a vertical axis 228, notably a first set (e.g., a first plane 230 and a second plane 232) and a second set (e.g., a third plane 234 and a fourth plane 236). As shown in FIG. 2, the planes 230, 232 and the planes 234, 236 are spaced apart from one another.

FIGS. 3 and 4 illustrate an example of the relationship between the fluid moving unit 202 and the maximum length of the installation envelope 226 (FIG. 2). At a high level, the structure 200 is configured so that substantially all of the components of the fluid moving unit 204 and the noise reduction structure fit within the installation envelope 226 (FIG. 2). This configuration may define one or more dimensions (e.g., a first dimension 238), at least one of which represents a maximum length for the fluid moving unit 204. FIGS. 5 and 6 illustrate an example of the relationship between the fluid moving unit 204 and the maximum width of the installation envelope 226 (FIG. 2). The configuration of the structure 200 defines one or more dimensions (e.g., a second dimension 240), at least one of which represents a maximum width for the fluid moving unit 204. In this example, the planes 230, 232, 234, 236 are tangent to at least one point on the support structure 200. The maximum length can assume values that are up to 10% greater than the overall length (L) of the fluid moving unit 204. The overall length (L) may be long enough to include the main components (e.g., blowers, motors, etc.) as well as peripheral piping within the installation envelope 226. In one implementation, the values for the first dimension 238 can effectively maintain the peripheral “ends” of the components 216, 218 within the installation envelope 226. The maximum width can assume values that are up to 10% greater than the overall width (W) of the fluid moving unit 204. This configuration maintains the peripheral “sides” of the components 216, 218 generally within the installation envelope 226. (FIG. 2). The peripheral “sides” can define the outer extent of the housing typical of the motor and blower in conventional installations. This disclosure, however, contemplates configuration in which the maximum length and/or maximum width is less than and greater than these values disclosed herein.

The lifting members 224 provide an interface with the support structure 200. This interface can accommodate interaction with cranes, fork-lift trucks, and like equipment that is useful to move the fluid-handling system 202 (including the support structure 200 and the fluid moving unit 204 disposed thereon). As noted above, the lifting members 224 can embody hooks and/or rings, as well as other devices that appropriately carry loads consistent with, e.g., the weight of the fluid-handling system 202. In some implementation, the lifting members 224 can integrate directly with the support structure 200 as welded pieces and/or machined features, although this disclosure also contemplates configurations in which the lifting members 224 are separate members that can couple (and/or decouple) with corresponding features (e.g., threaded openings) found on the support structure 200, as desired.

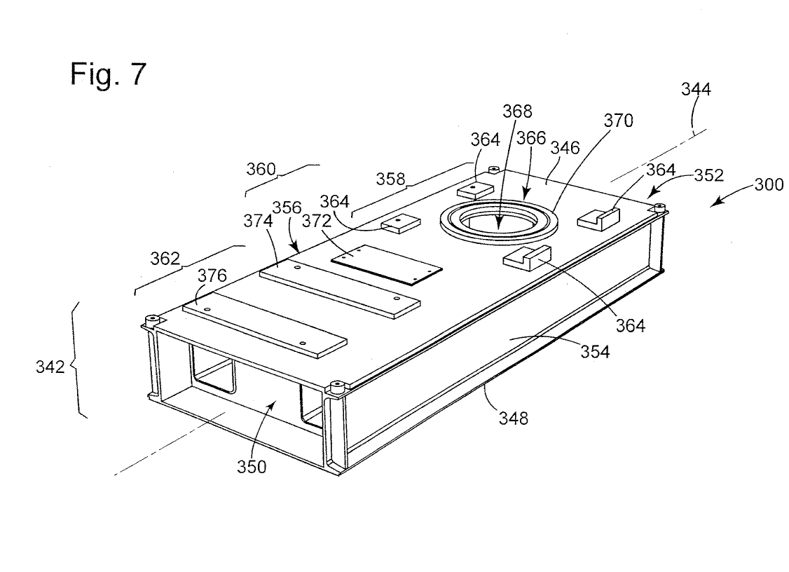

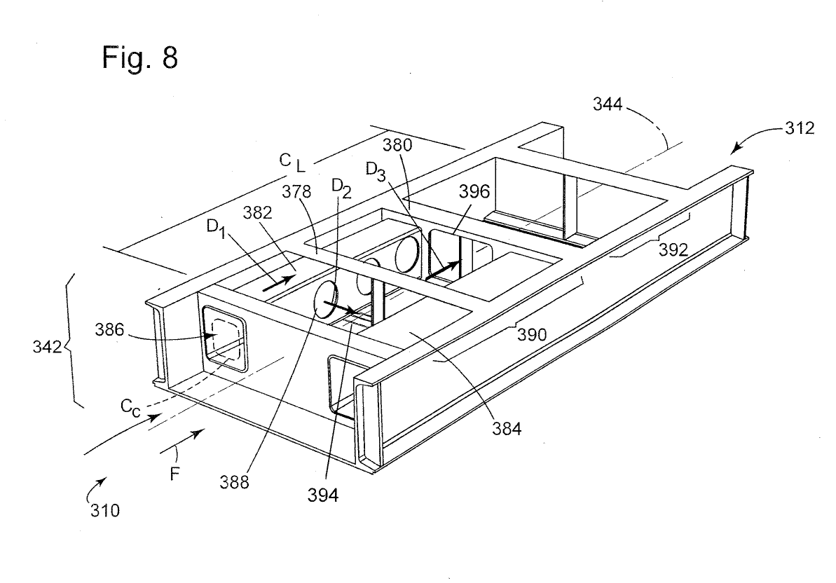

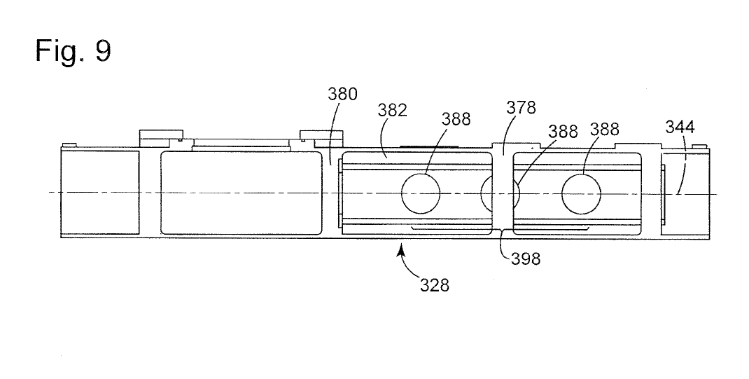

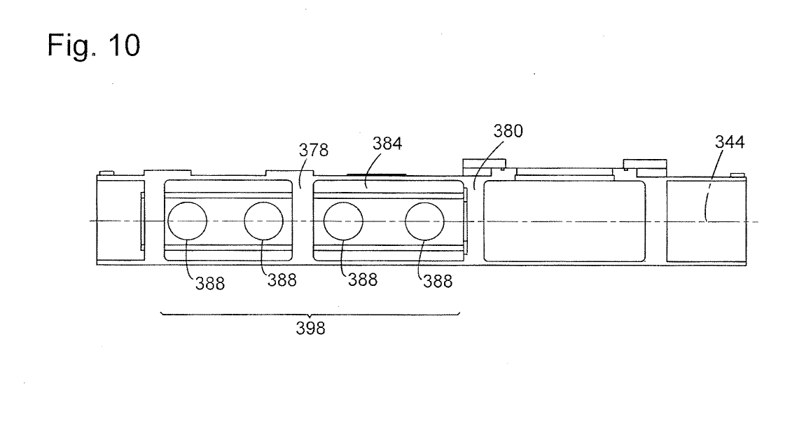

FIGS. 7, 8, 9, and 10 illustrate various views of an exemplary embodiment of a support structure 300 to illustrate an example of a noise reduction structure that can dissipate noise. FIG. 7 depicts a perspective view of the embodiment. FIG. 8 shows the interior of the support structure 300 to provide details of this noise reduction structure. FIGS. 9 and 10 illustrate an elevation view of a cross-section of the support structure 300 taken at, respectively, line 9-9 and line 10-10 of FIG. 7 to show certain features of the noise reduction structure.

Turning first to FIG. 7, the support structure 300 is configured to both support the components of a fluid moving unit (e.g., fluid moving unit 204 of FIG. 1) and to dissipate flow of working fluid therethrough. The support structure 300 can form an enclosure 342 with a longitudinal axis 344 that extends along the length of the support structure 300. The enclosure 342 can form an interior cavity that is bounded by a top member 346, a bottom member 348, end members (e.g., a first end member 350 and a second end member 352) disposed proximate the first end and the second end, respectively, and side members (e.g., a first side member 354 and a second side member 356). In one construction, the side members 354, 356 are coupled with each of the top member 346 and the bottom member 348 and the end members 350, 352 are coupled with each of the top member 346, the bottom member 348, and the side members 354, 356. The top member 346 can have a peripheral edge that defines a mounting area for the components of the fluid moving unit. This mounting area can include a first mounting location 358, a second mounting location 360, and a third mounting location 362, each being configured to receive a component of a fluid moving unit thereon. The peripheral edge circumscribes the first mounting location 358 and the second mounting location 360. The blower region 358 can include one or more blower mounts 364 that are disposed near (and/or proximate) a blower inlet member 366. The blower mounts 364 are disposed circumferentially about the inlet member 366 to match the blower component that will affix thereto. In the first mounting location 358, the blower inlet member 366 has a blower opening 368 that allows access to the interior of the enclosure 342. The blower inlet member 366 can also include a groove 370 that circumscribes the blower opening 368. The groove 370 can be configured to position a seal (not shown) circumferentially about the blower opening 368. Each of the coupling region 360 and the motor region 362 can include one or more coupling mounts, shown here in the form of one or more pads (e.g., a first pad 372, a second pad 374, and a third pad 376). These coupling mounts can receive other components of the fluid moving unit in combination with fasteners that are meant to secure these components to the support structure 300.

FIG. 8 shows the support structure 300 with the top member 346 (FIG. 7) removed both for clarity and to observe the interior of the enclosure 342. Generally, the enclosure 342 forms the interior cavity in which reside the components of the noise reduction structure. These components can include a pair of tubular members that are spaced laterally apart from the longitudinal axis. The pair of tubular members can include the tubular members 382, 384, as described herein. These components configure the enclosure and/or the noise reduction structure to change (or direct) the direction of the flow of working fluid F that transits the support structure 300, e.g., from the first end 310 to the second end 312. As shown in FIG. 8, the flow travels in a first direction D1, longitudinally along the longitudinal axis 344. The flow also travels in a second direction D2, laterally towards the longitudinal axis 344. The flow further travels in a third direction D3, longitudinally along the longitudinal axis 344 towards the blower opening 368 (FIG. 7) in the top member 346 (FIG. 7). Collectively, the change in direction (e.g., from the first direction D1 to the second direction D2 to the third direction D3) helps dissipate energy in the flow of working fluid F and, thus, suppress noise and pulses.

Continuing with the discussion of FIG. 8, the enclosure 342 can include one or more medial structural members (e.g., a first medial member 378 and a second medial member 380) extending laterally between the side members 354, 356 (FIG. 7) to form one or more chambers, as described further below. The enclosure 342 also includes an elongate tubular structure disposed in the interior cavity. This elongate tubular structure can include one or more (and/or a pair of) tubular members (e.g., a first tubular member 382 and a second tubular member 384), each with a forward opening 386 and one or more lateral openings 388. The tubular members 382, 384 are spaced laterally apart from the longitudinal axis 344, with each being disposed in FIG. 8 proximate the first side member 354 and the second side member 356, respectively. In one example, the forward opening 386 can form an open end (also, “inlet”) in the first end member 350 (FIG. 7). This open end can configure the enclosure with an inlet and an outlet (e.g., the blower opening 368 of FIG. 7) that is spaced apart from the inlet along the longitudinal axis 344 (FIG. 7). The tubular members 382, 384 can reside within the mounting area (noted above), thus rendering the support structure 300 with flow-dissipating features in a compact fowl factor. The tubular members 382, 384 can have one or more characteristic dimensions (e.g., a length C_{L}, an interior cross-section area C_{C}, etc.).

Construction of the enclosure 342 can utilize a multi-chamber approach for noise reduction. In FIG. 8, the enclosure 342 forms one or more flow chambers (e.g., a first flow chamber 390 and a second flow chamber 392. In one example, the tubular members 382, 384 reside within the first flow chamber 390, being spaced apart from one another to form a third flow chamber 394 (also “mixing chamber 394”) therebetween. The second medial member 380 can have an aperture 396 that is configured to expose the first flow chamber 390 with the second flow chamber 392. As best shown in FIGS. 9 and 10, the tubular members 382, 384 can have a first configuration 398 for the lateral openings 388. The first configuration 398 sets out positions for the lateral openings 388 in spaced relation to one another along the longitudinal axis 344. In one implementation, these positions are offset as between the tubular members 382, 384, wherein the position of the lateral openings 388 on the first tubular member 382 are different from the positions of the lateral openings 388 on the second tubular member 384. In one example, the one or more openings on the first tubular structure are longitudinally offset from the one or more openings on the second tubular structure.

As noted above, the noise reduction structure is configured to dissipate noise and pulses as the working fluid F flows through the enclosure 342. Moving from left to right in the diagram of FIG. 8, for example, the working fluid F can enter the first flow chamber 390 via the forward opening 386. In one implementation, the first end member 350 may be spaced apart from the peripheral edge of the members 346, 348, 354, 356 along the longitudinal axis 344 toward the second end of the support structure 300. This position configures the enclosure with a void (also, “filter zone”) that extends from the peripheral edge to the first end member 350. In one example, the filter zone is bounded circumferentially about the longitudinal axis 344 by the members 346, 348, 354, 356. In one example, the filter zone can accommodate a filter media that is useful to prevent contaminates from the interior of the enclosure 342. The filter media can be configured to couple with the support structure 300 proximate the first end. When installed, the filter media may be bounded circumferentially about the longitudinal axis 344 by the members 346, 348, 354, 356. The tubular members 382, 384 form a fluid pathway that directs the working fluid F into the mixing chamber 394 via the lateral openings 388. Here, the working fluid F from the first tubular member 382 mixes with the working fluid F of the second tubular member 384. The mixed flow of working fluid F continues to transit the first flow chamber 390, exiting through the aperture 396 into the second flow chamber 392. In one example, the first mounting location 358 (FIG. 7) is configured with an opening (e.g., the blower opening 368 of FIG. 7) that exposes the second flow chamber 392 of the interior cavity. This configuration allows the working fluid F to exit the second flow chamber 392 into the blower component 116 (FIG. 1) through the blower opening 368 (FIG. 7) in the top member 346 (FIG. 7).

Construction of the support structure 300 provides a robust platform that can support the various components of a blower installation. This construction can utilize materials of varying properties and combinations, most notably steel, iron, aluminum, and like materials of significant mechanical strength. The top and bottom members 346, 348 (FIG. 7) may embody plates and/or sheets that comprise these materials. The end members 352, 354 (FIG. 7) and medial members 378, 380 (FIG. 8) can likewise incorporate plates and/or sheets, alone and/or in combination with flat stock or bars to provide additional structural integrity. Such combination may also be suitable for use as the side members 350, 352 (FIG. 7), although it is also likely that the side members 354, 356 (FIG. 7) might embody I-beam and/or related geometry that may have improved strength and stiffness properties. Collectively, welds and/or fasteners may couple the members to one another to complete the support structure 300.

The elongate tubular members 382, 384 can include elements that operate to dissipate flow of the working fluid F. These elements can extend at least partially into the first flow chamber 390 along the longitudinal axis 344. As shown in FIG. 8, the elongate tubular members 382, 384 can have an open end (that forms the opening in the first end member 350). In one construction, the elongate tubular members 382, 384 can extend from the first end member 350 to the second medial member 380, which may cap the end of the elongate tubular members 382, 384 to form a closed end that is configured to prevent flow of fluid therefrom. The elongate tubular members 382, 384 can have a plurality of walls (e.g., four walls) that circumscribe a hollow interior. These walls may be extruded as a substantially unitary structure. In other implementations, the walls may embody individual pieces that are secured (e.g., welded) to one another and/or to the members of the support structure 300. In this way, the elongate tubular members 382, 384 form a void or hollow interior that can receive a fluid (e.g., the working fluid F). The opening in the first end member 350 can be configured to allow access to the hollow interior of the elongate tubular members 382, 384. As shown in FIG. 8, the tubular members 382, 384 can reside proximate each of the side members 354, 356. In one embodiment, the first tubular member 382 and the second tubular member 384 are spaced apart laterally from the longitudinal axis 344. The walls can include a first wall that extends along and is disposed inwardly of the first side member 354 and the second side member 356, effectively bounding the mixing chamber 394. This first wall faces inwardly towards the longitudinal axis 344. The lateral openings 388 populate the inwardly facing first wall. These lateral openings can be disposed longitudinally along the elongate tubular members 382, 384 and can be configured to expose the hollow interior to the first flow chamber 390. These features expose the hollow interior to the mixing chamber 394. During operation, this configuration forms a tortuous path that can dissipate energy in the working fluid F, and thus configure the support structure 300 to muffle and/or silence noise.

The characteristic dimensions are useful to describe geometry that can modify the flow of working fluid F. Broadly, suitable geometry does not amplify vibrations and/or other perturbations that can occur in response to the flow of fluid through the enclosure 342. Values for the length C_{L}, for example, often depend on the operating characteristics of the blower (and/or the fluid moving unit 104 (FIG. 1)). These operating characteristics can include blower speed. During operation, the blower speed can cause the blower to vibrate at a frequency that is input to the enclosure 342. For improperly sized components, mismatch between the length C_{L} and the input frequency will cause the elongate members 382, 384 to resonate at the frequency, which can create and/or exacerbate noise. In other implementations, values for the cross-section area C_{C} depend on the dimensions of the inlet to the blower. These values are set to avoid restricting flow of fluid, often in a manner that avoids requiring additional work by the blower to “pull” fluid through the enclosure 342. In one example, the values are selected so that the cross-section area C_{C} along the members 382, 384 is equal to or larger than the inlet to the blower.

The second flow chamber 392 defines a void in the enclosure that can further dissipate energy in the working fluid F. This void can receive flow of working fluid F from the mixing chamber 394. The flow transits the second medial member 380, which effectively operates as a boundary between the first flow chamber 390 and the second flow chamber 392. As shown in FIG. 8, the second flow chamber 392 does not require any additional components (e.g., baffles) to further dissipate energy in the working fluid F; however, this requirement is not absolute, and thus this disclosure contemplates configurations for the noise reduction structure that may include other components disposed in the second flow chamber 392, as desired.

As used herein, an element or function recited in the singular and proceeded with the word “a” or “an” should be understood as not excluding plural said elements or functions, unless such exclusion is explicitly recited. Furthermore, references to “one embodiment” of the claimed invention should not be interpreted as excluding the existence of additional embodiments that also incorporate the recited features.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A support structure for use to support a fluid moving unit, comprising:
an enclosure with a first end, a second end, and a longitudinal axis extending therebetween, the enclosure forming an interior cavity with a first flow chamber and a second flow chamber, the enclosure comprising,
a top member and a bottom member, the top member having a first mounting location and a second mounting location, one each configured to receive a component of the fluid moving unit, respectively, wherein the first mounting location is configured with an opening that exposes the second flow chamber of the interior cavity,
a first side member and a second side member coupled with each of the top member and the bottom member, and
a first end member and a second end member disposed proximate the first end and the second end, respectively, and coupled with each of the first side member, the second side member, the top member, and the bottom member; and
an elongate tubular member disposed in the interior cavity within the first flow chamber, the elongate tubular member having a hollow interior, an open end, and a closed end that is configured to prevent flow of fluid therefrom, the open end forming a first opening in the first end member that is configured to allow access to the hollow interior, the elongate tubular member also comprising a first wall extending along and disposed inwardly of the first side member and the second side member, the first wall having one or more openings disposed longitudinally along the elongate tubular member, the one or more openings configured to expose the hollow interior of the elongated tubular member to the first flow chamber.

2. The support structure of claim 1, wherein the elongate tubular member comprises a first tubular member and a second tubular member, one each disposed proximate the first side member and the second side member and spaced apart from one another to form a mixing chamber therebetween.

3. The support structure of claim 2, wherein the one or more openings on the first tubular member are longitudinally offset from the one or more openings on the second tubular member.

4. The support structure of claim 1, further comprising a medial member extending laterally between the first side member and the second side member to form the first flow chamber and the second flow chamber.

5. The support structure of claim 4, wherein the medial member comprises has an aperture that is configured to expose the first flow chamber to the second flow chamber.

6. The support structure of claim 4, wherein the medial member is configured to form the closed end of the elongate tubular member.

7. The support structure of claim 1, wherein the top member has a peripheral edge, and wherein the first end member is spaced apart from the peripheral edge along the longitudinal axis toward the second end.

8. The support structure of claim 7, wherein the enclosure has a void that extends from the peripheral edge to the first end member, and wherein the void is bounded circumferentially about the longitudinal axis by the top member, the bottom member, the first side member, and the second side member.

9. The support structure of claim 1, further comprising a lifting member that is configured to direct a load to the enclosure.

10. A structure for mounting a fluid moving unit, said structure comprising:
an enclosure forming an interior cavity, the enclosure having an inlet and an outlet spaced apart from the inlet along a longitudinal axis, the enclosure forming a mounting area with a first mounting location and a second mounting location that are configured to receive a component of the fluid moving unit thereon,
a first tubular member disposed in the interior cavity and extending along the longitudinal axis within the mounting area;
a second tubular member disposed in the interior cavity and extending along the longitudinal axis within the mounting area,
wherein the first tubular member and the second tubular member have a plurality of walls that circumscribe a hollow interior, and wherein the first tubular member and the second tubular member have an open end coupled with the inlet and a closed end that is configured to prevent flow of fluid therefrom, the plurality of walls comprising a first wall having an opening that exposes the hollow interior to the interior cavity.

11. The structure of claim 10, wherein the enclosure is configured to direct fluid in a first direction within the first tubular member and the second tubular member, longitudinally along the longitudinal axis from the first end, in a second direction, laterally towards the longitudinal axis, and in a third direction, longitudinally along the longitudinal axis towards the opening in the top member.

12. The structure of claim 10, wherein the first tubular member and the second tubular member are spaced apart laterally from the longitudinal axis, and wherein the first wall faces inwardly towards the longitudinal axis.

13. A fluid-handling system, comprising:
a support structure comprising an enclosure with a first end, a second end, and a longitudinal axis extending therethrough, the enclosure forming an interior cavity bounded by a top member and a bottom member, a first side member and a second side member, a first end member and a second end member, the top member having a first mounting location and a second mounting location, the first mounting location having an opening that exposes the interior cavity;
a first component of a fluid moving unit configured to couple with the top member at the first mounting location; and
a drive unit configured to couple with the top member at the second mounting location, the drive unit configured to operate the first component,
wherein the enclosure includes a noise reduction structure disposed in the interior cavity of the support structure, and
wherein the noise reduction structure is configured to direct fluid in a first direction, longitudinally along the longitudinal axis from the first end, in a second direction, laterally towards the longitudinal axis, and in a third direction, longitudinally along the longitudinal axis towards the opening in the top member.

14. The fluid-handling system of claim 13, wherein the noise reduction structure forms a pair of tubular members that are spaced laterally apart from the longitudinal axis, wherein each of the tubular members has a hollow interior, and wherein each of the tubular members are configured to expose the hollow interior to the interior cavity.

15. The fluid-handling system of claim 14, wherein the pair of tubular members comprise a first tubular member and a second tubular member, each having one or more openings disposed on a wall that extends longitudinally in the interior cavity.

16. The fluid-handling system of claim 15, wherein the one or more openings on the first tubular member are longitudinally offset from the one or more openings on the second tubular member.

17. The fluid-handling system of claim 13, wherein the top member has a peripheral edge that circumscribes the first mounting location and the second mounting location, and wherein the first component and the drive unit fit within an installation envelope that comprises a plurality of planes that are tangent to at least one point on a peripheral edge of the top member, the planes comprising a first plane and a second plane proximate the first end and the second end, respectively, and parallel to one another, and a third plane and a fourth plane proximate the first side member and the second side member, respectively, and parallel to one another.

18. The fluid handling system of claim 17, wherein the first end member is offset longitudinally from the peripheral edge.

19. The fluid-handling system of claim 18, further comprising a filter media configured to couple with the support structure proximate the first end, wherein the filter media is bounded circumferentially about the longitudinal axis by the top member, the bottom member, the first side member, and the second side member.

20. The fluid-handling system of claim 18, wherein the bottom member, the first side member and the second side member, and the first end member and the second end member fit within the installation envelope.
